(19) United States
(12) Patent Application Publication
(10) Pub. No.: US 2022/0066503 A1
(43) Pub. Date: Mar. 3, 2022

(54) TRANSLATING MEMBERS

(71) Applicant: Hewlett-Packard Development Company, L.P., Spring, TX (US)

(72) Inventors: Arthur Harvey Zarnowitz, Palo Alto, CA (US); Glenn A. Wong, Palo Alto, CA (US); Kevin l. Massaro, Spring, TX (US); Andrew Guscott, Palo Alto, CA (US); Har Lee, Palo Alto, CA (US); Isaac Teece, Palo Alto, CA (US); Marcus Hoggarth, London (GB)

(73) Assignee: Hewlett-Packard Development Company, L.P., Spring, TX (US)

(21) Appl. No.: 17/418,895

(22) PCT Filed: Apr. 30, 2019
(86) PCT No.: PCT/US2019/029933

§ 371 Date: Jun. 28, 2021

(51) Int. Cl. G06F 1/16

(52) U.S. Cl. CPC G06F 1/1624; G06F 1/1681

(57) ABSTRACT

In some examples, an apparatus can include a first support member housing a first spring, a second support member housing a second spring, a top crossbar member connected to the first support member and the second support member, and a base crossbar member connected to the first support member and the second support member, where the first support member, the second support member, and the top crossbar member translate relative to the base crossbar member in response to an applied force.

### BACKGROUND

Electronic devices may include a display. A display can present images, text, and/or video to a user. Some displays may be connected to a display frame. In some examples, the frame may include an apparatus to alter a viewing angle of the display. The altered viewing angle can allow a user to view and/or input information to the electronic device via the display.

### BRIEF DESCRIPTION OF THE DRAWINGS

FIG. 1 illustrates a front view of an example of an apparatus with translating members consistent with the disclosure.

FIG. 2 illustrates a front view of an example of a system including an apparatus with translating members and a display consistent with the disclosure.

FIG. 3 illustrates a perspective view of an example of a system including an apparatus with translating members and a display consistent with the disclosure.

FIG. 4 illustrates a perspective view of an example of a system including an apparatus with translating members and a display in a translated state consistent with the disclosure.

FIG. 5 illustrates a side view of an example of a system including a first support member in a non-translated state and in a translated state consistent with the disclosure.

### DETAILED DESCRIPTION

Electronic devices such as laptops, phablets, mobile devices (e.g., such as mobile phones), tablets, televisions, monitors, convertibles, and other types of electronic devices may include a display. As used herein, the term “display” can, for example, refer to a device which can provide information to a user and/or receive information from a user. A display can include a graphical user interface (GUI) that can provide information to and/or receive information from a user.

A display may be connectable to a frame. In such an example, a frame may allow for modification of a viewing angle of the display. For instance, a display may be rotation and/or height adjustable for viewing at various angles.

An apparatus with translating members can allow for height adjustment of a display and/or rotational adjustment of the display. The apparatus can include a lift mechanism to allow for height adjustment of the display and a rotational mechanism to allow for rotational adjustment of the display. Height and rotational adjustment of the display can allow for viewing of the display at various angles, which may allow for the display to be more easily viewed and/or allow for ease of input of information to the display.

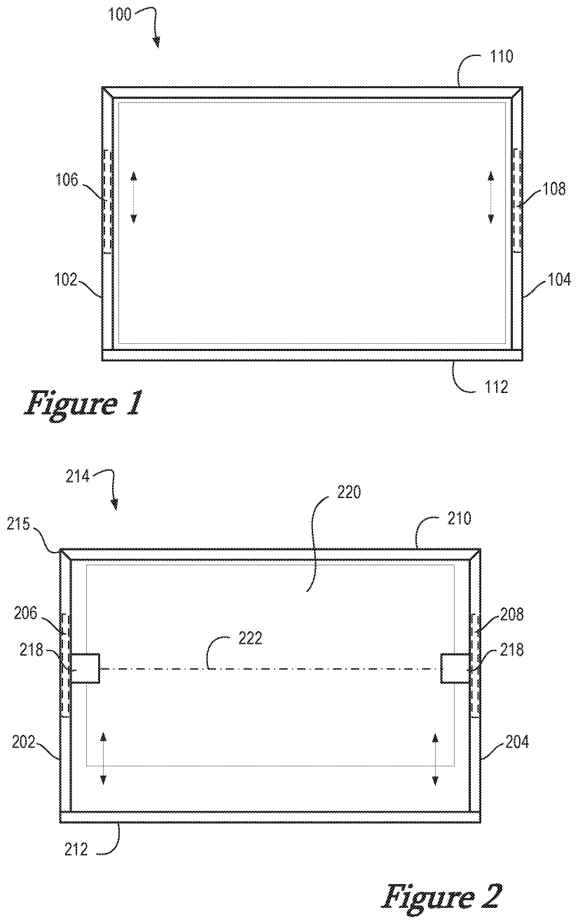

FIG. 1 illustrates a front view of an example of an apparatus 100 with translating members consistent with the disclosure. Apparatus 100 can include a first support member 102, a second support member 104, a first coil spring 106, a second coil spring 108, a top crossbar member 110, and a base crossbar member 112.

As illustrated in FIG. 1, apparatus 100 can include a first support member 102. As used herein, the term “support member” refers to a structural constituent part of a structural system. For example, first support member 102 can be a structural member of apparatus 100.

First support member 102 can house a first spring 106. As used herein, the term “spring” refers to a mechanical device that can store mechanical energy. For example, first spring 106 can be a coil spring. For instance, first spring 106 can be a spring in the shape of a helix that can compress to store mechanical energy and decompress to release the stored mechanical energy. As used herein, the term “compress” can, for example, refer to pressing together. In some examples, first spring 106 can be a constant coil spring. As used herein, the term “constant coil spring” refers to a spring having a linear spring rate. For instance, in such an example, first spring 106 can have a constant spring rate at every point in the compression distance of first spring 106.

Although first spring 106 is described above as being a coil spring and/or a constant coil spring, examples of the disclosure are not so limited. For example, first spring 106 can be any other type of spring, and/or can be a variable spring rate spring.

As illustrated in FIG. 1, apparatus 100 can include a second support member 104. For example, second support member 104 can be a structural member of apparatus 100.

Second support member 104 can house a second spring 108. Second spring 108 can be a coil spring. For instance, second spring 108 can be a spring in the shape of a helix that can compress to store mechanical energy and decompress to release the stored mechanical energy. In some examples, second spring 108 can be a constant coil spring. For instance, in such an example, second spring 108 can have a constant spring rate at every point in the compression distance of second spring 108.

Although second spring 108 is described above as being a coil spring and/or a constant coil spring, examples of the disclosure are not so limited. For example, second spring 108 can be any other type of spring, and/or can be a variable spring rate spring.

Apparatus 100 can include a top crossbar member 110. As used herein, the term “crossbar member” refers to a structural constituent part of a structural system. For example, top crossbar member 110 can be a structural member of apparatus 100.

As illustrated in FIG. 1, top crossbar member 110 can be connected to the first support member 102 and the second support member 104. Top crossbar member 110 can be connected at a “top” of the first support member 102 and second support member 104 as oriented in FIG. 1. Top crossbar member 110 may be connected to the first support member 102 and the second support member 104 by a fastener, an adhesive, be assembled, be welded, etc.

Apparatus 100 can include a base crossbar member 112. For example, base crossbar member 112 can be a structural member of apparatus 100.

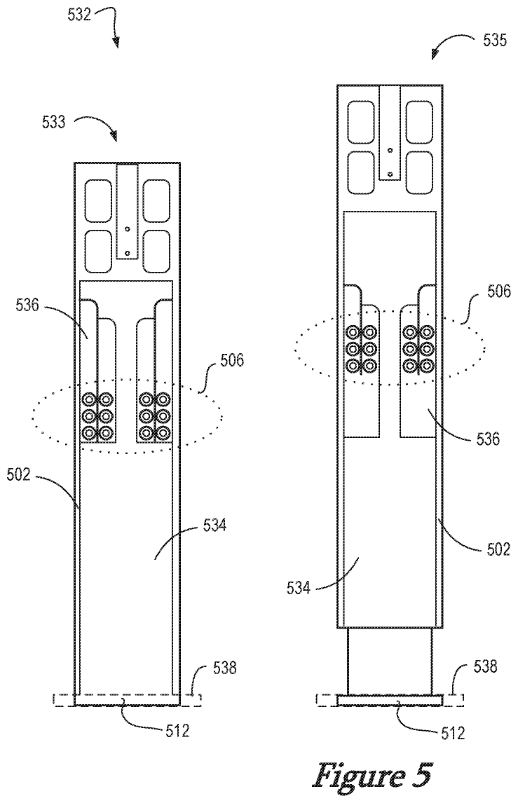

As illustrated in FIG. 1, base crossbar member 112 can be connected to the first support member 102 and the second support member 104. Base crossbar member 112 can be connected at a “bottom” of the first support member 102 and second support member 104 as oriented in FIG. 1. In some examples, base crossbar member 112 may be connected to the first support member 102 and the second support member 104 by shafts of the base crossbar member 112 located in guide slots of the first support member 102 and the second support member 104, respectively, as is further described in connection with FIG. 5. In some examples, base crossbar member 112 may be connected to the first support member 102 and the second support member 104 by a fastener, an adhesive, be assembled, be welded, etc.

First support member 102, second support member 104, top crossbar member 110, and base crossbar member 112 can be the same material, different materials, etc. For example, first support member 102, second support member 104, top crossbar member 110, and base crossbar member 112 can be die cast and/or sheet metal components, machined metal components, molded plastic components, extruded components assembled together, and/or combinations thereof. Further, examples of the disclosure are not limited to the above materials.

The first support member 102, second support member 104, and top crossbar member 110 can translate relative to base crossbar member 112 in response to an applied force. As used herein, the term “translate” refers to movement from one position to another position without rotation or angular displacement. For example, first support member 102, second support member 104, and top crossbar member 110 can move from a non-translated state (e.g., as illustrated in FIG. 1) to a translated state (e.g., as illustrated and further described in connection with FIG. 4) relative to base crossbar member 112.

The applied force can be a force applied to, for instance, top crossbar member 110. Top crossbar member 110 can be connected to first support member 102 and second support member 104 such that, in response to the force being applied to top crossbar member 110, the top crossbar member 110, first support member 102, and second support member 104 can translate (e.g., move linearly away from or towards) base crossbar member 112. For example, a user intending to adjust the height of the apparatus 100 can apply a force to top crossbar member 110 to cause translation of the top crossbar member 110, first support member 102, and second support member 104.

However, examples of the disclosure are not so limited. For example, a user can grip a support member (e.g., first support member 102 and/or second support member 104) and pull up or down to cause translation of the top crossbar member 110, first support member 102, and second support member 104, among other examples.

In some examples, first support member 102 can include a hinge connection mechanism. Additionally, second support member 104 can include a hinge control mechanism, as is further described in connection with FIGS. 2-4.

FIG. 2 illustrates a front view of an example of a system 214 including an apparatus with translating members and a display 220 consistent with the disclosure. System 214 can include a frame 215 and a display 220. Frame 215 can include a first support member 202, a second support member 204, a top crossbar member 210, and a base crossbar member 212. First support member 202 can include a first coil spring 206 and a first hinge connection mechanism 216. Second support member 204 can include a second coil spring 208 and a second hinge connection mechanism 218.

System 214 can include a frame 215. As used herein, the term “frame” refers to a rigid structure joined so as to surround an empty space. Similar to the apparatus described in connection with FIG. 1, frame 215 can include a first support member 202, a second support member 204, a first coil spring 206, a second coil spring 208, a top crossbar member 210, and a base crossbar member 212. Top crossbar member 210 can be connected to the first support member 202 and the second support member 204. Base crossbar member 212 can be connected to the first support member 202 and the second support member 204 by shafts of the base crossbar member 212 located in guide slots of the first support member 202 and the second support member 204, respectively, as is further described in connection with FIG. 5.

First support member 202 can include a first constant coil spring 206. First constant coil spring 206 can be similar to spring 106, previously described in connection with FIG. 1.

First support member 202 can include a first hinge connection mechanism 216. As used herein, the term “hinge connection mechanism” refers to a device on which an attached part moves. For example, first hinge connection mechanism 216 can connect to a part to allow the part to rotate. The connected part can be, in some examples, a display 220, as is further described herein.

Second support member 204 can include a second constant coil spring 208. Second constant coil spring 208 can be similar to spring 108, previously described in connection with FIG. 1.

Second support member 204 can include a second hinge connection mechanism 218. For example, second hinge connection mechanism 218 can connect to a part to allow the part to rotate. The connected part can be, in some examples, a display 220, as is further described herein.

First hinge connection mechanism 216 and second hinge connection mechanism 218 can be friction hinges. As used herein, the term “friction hinge” refers to a hinge having a constant internal friction to hold its position. For example, first hinge connection mechanism 216 and second hinge connection mechanism 218 can be friction hinges that hold their positions due to internal friction within the hinge connection mechanisms unless acted on by an external force, as is further described herein.

As illustrated in FIG. 2, display 220 can be connected to frame 215. Display 220 can be connected to frame 215 via first hinge connection mechanism 216 and second hinge connection mechanism 218. For example, display 220 can be connected to first hinge connection mechanism 216 and second hinge connection mechanism 218 to allow display 220 to rotate via the first hinge connection mechanism 216 and second hinge connection mechanism 218.

Display 220 can be connected to frame 215 along a center of gravity axis 222 of display 220. As used herein, the term “center of gravity axis” refers to a line that bisects a center of gravity of an object, where the line is a line about which a rotating body turns. Connection of the display 220 to frame 215 along the center of gravity axis 222 of display 220 can allow for rotation of display 220 relative to the frame 215 along/about the center of gravity axis 222 in response to an applied force. Rotation of the display 220 about the center of gravity axis 222 can allow a user to rotate the display 220 to view the display 220 at various angles. For example, a user may prefer to view the display at a particular angle and push/pull (e.g., apply a force to display 220) on the display 220 to cause display 220 to rotate. As previously described above, first hinge connection mechanism 216 and second hinge connection mechanism 218 can be friction hinges such that the friction hinges hold their positions due to internal friction within the hinge connection mechanisms 216, 218 unless acted on by an external force. In other words, the display 220 can stay in a particular position due to the friction hinges unless the display 220 is rotated in response to an applied force on the display 220.

The first support member 202, second support member 204, top crossbar member 210, and display 220 can translate relative to base crossbar member 212 in response to an applied force. For example, first support member 202, second support member 204, top crossbar member 210, and display 220 can move from a non-translated state (e.g., as illustrated in FIG. 2) to a translated state (e.g., as illustrated and further described in connection with FIG. 4) relative to base crossbar member 212. For example, a user intending to adjust the height of the frame 215 and display 220 can apply a force to cause translation of the top crossbar member 210, first support member 202, second support member 204, and display 220. Translation of the frame 215 and display 220 can allow a user to adjust the height of the display 220 to view the display 220 at a selected angle/height.

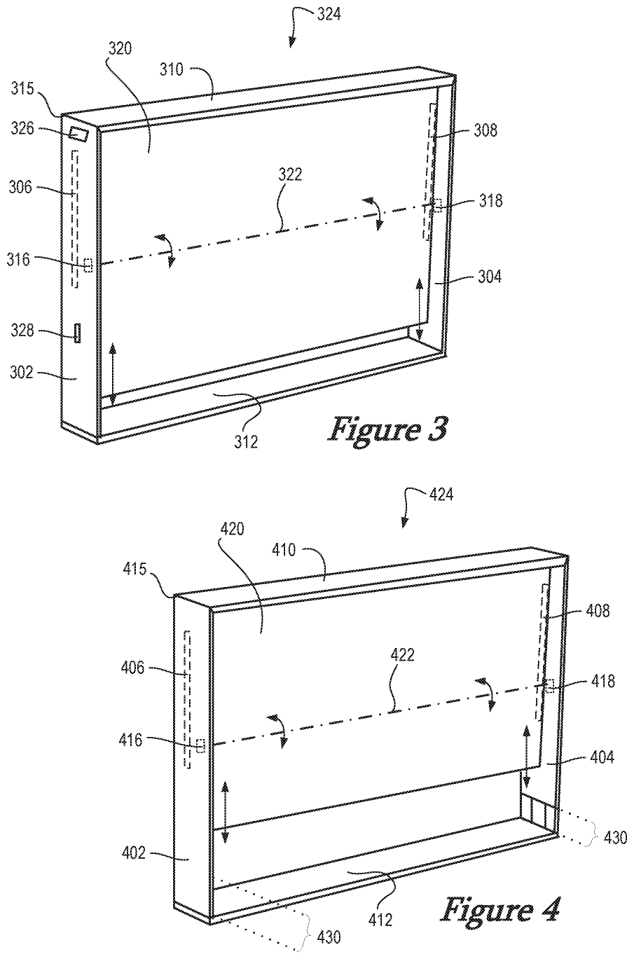

In some examples, the first support member 202, second support member 204, top crossbar member 210, and display 220 can translate vertically away from base crossbar member 212 in response to an applied force, as is further described in connection with FIGS. 3 and 4. Further, in some examples, the first support member 202, second support member 204, top crossbar member 210, and display 220 can translate vertically towards from base crossbar member 212 in response to an applied force, as is further described in connection with FIGS. 3 and 4.

FIG. 3 illustrates a perspective view of an example of a system 324 including an apparatus with translating members and a display 320 consistent with the disclosure. System 324 can include a frame 315 and a display 320. Frame 315 can include a first support member 302, a second support member 304, a top crossbar member 310, a base crossbar member 312, an electrical connection 326, and a magnetic connection mechanism 328. First support member 302 can include a first coil spring 306 and a first hinge connection mechanism 316. Second support member 304 can include a second coil spring 308 and a second hinge connection mechanism 318.

Similar to the system described in connection with FIG. 2, frame 315 can include a first support member 302, a second support member 304, a first coil spring 306, a second coil spring 308, a top crossbar member 310, and a base crossbar member 312. Top crossbar member 310 can be connected to the first support member 302 and the second support member 304. Base crossbar member 312 can be connected to the first support member 302 and the second support member 304 by shafts of the base crossbar member 312 located in guide slots of the first support member 302 and the second support member 304, respectively, as is further described in connection with FIG. 5. First support member 302 can include first hinge connection mechanism 316 and second support member 304 can include second hinge connection mechanism 318. Display 320 can be connected to the frame 315 via the first hinge connection mechanism 316 and the second hinge connection mechanism 318.

Frame 315 can include electrical connection 326. As used herein, the term “electrical connection” refers to an electro-mechanical device used to join electrical terminations to create an electrical circuit. For example, electrical connection 326 can allow for an electrical signal to be communicated from a computing device component to display 320. As used herein, the term “computing device component” refers to a device that connects to a computing device system to add functionality to the computing device system. For example, computing device components may include a speaker, camera, microphone, light, mouse, keyboard, etc. In other words, a user may utilize a computing device component with frame 315 and display 320 by plugging in a computing device component into electrical connection 326.

Although frame 315 is illustrated in FIG. 3 as including a single electrical connection 326, examples of the disclosure are not so limited. For example, frame 315 can include more than one electrical connection 326, and the more than one electrical connection 326 can be located in any other location on frame 315.

Frame 315 can include magnetic connection mechanism 328. As used herein, the term “magnetic connection mechanism” refers to a magnetic device which can attach a peripheral computing device component to frame 315. For example, magnetic connection mechanism 328 can be magnetically connected to frame 315. Magnetic connection mechanism 328 can include instruments to allow for the connection to accessory/peripheral computing device components. For example, magnetic connection mechanism 328 can include a hanger, clip, etc. The hangers, clips, etc. can be utilized to connect to various accessory components. Accessory components can include lights, microphone booms, etc.

The location of magnetic connection mechanism 328 on frame 315 can be modifiable. For example, if a user is utilizing magnetic connection mechanism 328 to hold a light, the user can move the magnetic connection mechanism 328 to another location on frame 315 to better utilize the light, among other examples.

Although frame 315 is illustrated in FIG. 3 as including a single magnetic connection mechanism 328, examples of the disclosure are not so limited. For example, frame 315 can include more than one magnetic connection mechanism 328, and the more than one magnetic connection mechanism 328 can be located in any other location on frame 315.

Similar to frame 215 previously described in connection with FIG. 2, first support member 302, second support member 304, top crossbar member 310, and display 320 can translate relative to base crossbar member 312 in response to an applied force. For example, first support member 302, second support member 304, top crossbar member 310, and display 320 can move from a non-translated state (e.g., as illustrated in FIG. 3) to a translated state (e.g., as illustrated and further described in connection with FIG. 4) relative to base crossbar member 312.

FIG. 4 illustrates a perspective view of an example of a system 424 including an apparatus with translating members and a display 420 in a translated state consistent with the disclosure. System 424 can include a frame 415 and a display 420.

Similar to the system described in connection with FIG. 3, frame 415 can include a first support member 402, a second support member 404, a first coil spring 406, a second coil spring 408, a top crossbar member 410, and a base crossbar member 412. Top crossbar member 410 can be connected to the first support member 402 and the second support member 404. Base crossbar member 412 can be connected to the first support member 402 and the second support member 404 by shafts of the base crossbar member 412 located in guide slots of the first support member 402 and the second support member 404, respectively, as is further described in connection with FIG. 5. First support member 402 can include first hinge connection mechanism 416 and second support member 404 can include second hinge connection mechanism 418. Display 420 can be connected to the frame 415 via the first hinge connection mechanism 416 and the second hinge connection mechanism 418.

As illustrated in FIG. 4, the first support member 402, second support member 404, top crossbar member 410, and display 420 are in a translated state. For example, first support member 402, second support member 404, top crossbar member 410, and display 420 are translated vertically away from base crossbar member 412 by translation length 430. In other words, first support member 402, second support member 404, top crossbar member 410, and display 420 can be raised by a height equal to translation length 430. Translation of first support member 402, second support member 404, top crossbar member 410, and display 420 can be in response to an applied force. Further, first support member 402, second support member 404, top crossbar member 410, and display 420 can be translated (e.g., lowered) by a height equal to translation length 430 in response to an applied force.

As previously described in connection with FIGS. 2 and 3, display 420 can be rotatable. Display 420 can be rotatable about center of gravity axis 422 in response to an applied force to display 420. Display 420 can be rotatable about center of gravity axis 422 utilizing first hinge connection mechanism 416 and second hinge connection mechanism 418,

FIG. 5 illustrates a side view of an example of a system 532 including a first support member 502 in a non-translated state 533 and in a translated state 535 consistent with the disclosure. System 532 can include first support member 502 and base crossbar member 512. First support member 502 can include first coil springs 506, first guide slot 536. Base crossbar member 512 can include first shaft 534.

First support member 502 can include spring 506. Spring 506 can assist in translation of the first support member 502, top crossbar member (e.g., top crossbar member 110, 210, 310, 410, previously described in connection with FIGS. 1-4, respectively), second support member (e.g., second support member 104, 204, 304, 404, previously described in connection with FIGS. 1-4, respectively), and a display (e.g., display 220, 320, 420, previously described in connection with FIGS. 2-4, respectively). Springs 506 can provide a parallel, smooth operation of the translation of the first support member 502, top crossbar member, second support member, and the display. Although not illustrated in FIG. 5 for clarity and so as not to obscure examples of the disclosure, system 532 can include a second support member having springs 506.

As illustrated in FIG. 5, base crossbar member 512 can include a first shaft 534. As used herein, the term “shaft” refers to a slender straight bar. First shaft 534 can be utilized to help support first support member 502. As illustrated in FIG. 5, first shaft 534 can be located inside of first guide slot 536. As used herein, the term “guide slot” refers to a depression/opening to receive a shaft. For example, first guide slot 536 can be included as part of first support member 502 and can receive first shaft 534. In other words, first guide slot 536 of first support member 502 can be shaped such that the first shaft 534 of base crossbar member 512 is located in first guide slot 536.

Although not illustrated in FIG. 5 for clarity and so as not to obscure examples of the disclosure, the base crossbar member 512 can further include a second shaft substantially similar to first shaft 534. Further, the second support member can include a second guide slot substantially similar to the first guide slot 536 and shaped such that the second shaft of base crossbar member 512 is located in the second guide slot.

The first shaft 534 can guide translation of the first support member 502 relative to the base crossbar member 512 in response to an applied force. For example, when adjusting a height of the frame including first support member 502, the first shaft 534 can guide translation of the first support member 502. Further, the second shaft of the base crossbar member 512 (e.g., not shown in FIG. 5) can guide translation of the second support member relative to the base crossbar member 512 in response to the applied force.

Although not illustrated in FIG. 5 for clarity and so as not to obscure examples of the disclosure, system 532 can include a rack and pinion mechanism. As used herein, the term “rack and pinion mechanism” refers to a linear actuator comprising a pair of gears which convert rotational motion into linear motion. For example, the rack and pinion mechanism can utilize gears such that the first support member 502 and the second support member (e.g., not illustrated in FIG. 5) translate in parallel relative to each other in response to an applied force. In other words, the rack and pinion mechanism ensures a distance of translation of the first support member 502 is the same distance of translation of the second support member in response to the applied force (e.g., parallel translation).

As illustrated in FIG. 5, in some examples, base crossbar member 512 can include an extended width 538. In other words, system 532 can include an extended width base crossbar member 538. The extended width base crossbar member 538 can have a width that is greater than the width of first support member 502, second support member (e.g., not illustrated in FIG. 5), and/or the top crossbar member (e.g., not illustrated in FIG. 5). The extended width base crossbar member 538 can have an expanded width to provide improved stability for system 532.

In some examples, base crossbar member 512 (e.g., and/or extended width base crossbar member 538) can include a weight that is greater than the weight of first support member 502, the second support member, and/or the top crossbar member. The increased weight can help provide improved stability for system 532.

An apparatus with translating members can allow for height adjustment of a display and/or rotational adjustment of a display connected to the apparatus. Height and/or rotational adjustment of the display can allow for viewing of the display at various angles, which may allow for the display to be more easily viewed and/or allow for ease of input of information to the display.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing,

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure, Since many examples can be made without departing from the spirit and scope of the system and method of the disclosure, this specification merely sets forth some of the many possible example configurations and implementations.

What is claimed is:

1. An apparatus, comprising:
a first support member housing a first spring;
a second support member housing a second spring;
a top crossbar member connected to the first support member and the second support member; and
a base crossbar member connected to the first support member and the second support member;
wherein the first support member, the second support member, and the top crossbar member translate relative to the base crossbar member in response to an applied force.

2. The apparatus of claim 1, wherein:
the base crossbar member includes a first shaft and a second shaft;
the first support member includes a first guide slot having a shape such that the first shaft of the base crossbar member is located in the first guide slot; and
the second support member includes a second guide slot having a shape such that the second shaft of the base crossbar member is located in the second guide slot.

3. The apparatus of claim 2, wherein:
the first shaft is to guide translation of the first support member relative to the base crossbar member via the first guide slot in response to the applied force; and
the second shaft is to guide translation of the second support member relative to the base crossbar member via the second guide slot in response to the applied force.

4. The apparatus of claim 1, wherein the apparatus further includes a magnetic connection mechanism to attach a peripheral computing device component to the apparatus.

5. The apparatus of claim 1, wherein the base crossbar member has a width that is greater than a width of the first support member, a width of the second support member, and a width of the top crossbar member.

6. The apparatus of claim 1, wherein:
the first support member includes a first hinge connection mechanism; and
the second support member includes a second hinge connection mechanism,

7. The apparatus of claim 6, wherein the first hinge connection mechanism and the second hinge connection mechanism are connectable to a display.

8. A system, comprising:
a frame, including:
a first support member housing a first constant coil spring and including a first hinge connection mechanism;
a second support member housing a second constant coil spring and including a second hinge connection mechanism;
a top crossbar member connected to the first support member and the second support member; and
a base crossbar member connected to the first support member and the second support member; and
a display connected to the frame via the first hinge connection mechanism and the second hinge connection mechanism;
wherein the top crossbar member and the display translate vertically relative to the base crossbar member in response to an applied force.

9. The system of claim 8, wherein the frame further includes a rack and pinion mechanism such that the first support member and the second support member translate in parallel relative to each other in response to the applied force.

10. The system of claim 8, wherein the display is connected to the frame along a center of gravity axis of the display such that the display rotates relative to the frame along the center of gravity axis of the display in response to the applied force.

11. A system, comprising:
a frame, including:
a first support member housing a first constant coil spring and including a first hinge connection mechanism;
a second support member housing a second constant coil spring and including a second hinge connection mechanism;
a top crossbar member connected to the first support member and the second support member; and
a base crossbar member connected to the first support member and the second support member; and
a display connected to the frame via the first hinge connection mechanism and the second hinge connection mechanism;
wherein the first support member, the second support member, the top crossbar member, and the display translate vertically relative to the base crossbar member in response to an applied force.

12. The system of claim 11, wherein the first support member, the second support member, the top crossbar member, and the display translate vertically away from the base crossbar member in response to an applied force.

13. The system of claim 11, wherein the first support member, the second support member, the top crossbar member, and the display translate vertically towards from the base crossbar member in response to an applied force.

14. The system of claim 11, wherein the frame includes an electrical connection to receive a computing device component such that an electrical signal is communicable from the computing device component to the display via the electrical connection.

15. The system of claim 11, wherein the first hinge connection mechanism and the second hinge connection mechanism are friction hinges.
